(19) United States
(12) Patent Application Publication
(10) Pub. No.: US 2017/0137206 A1
(43) Pub. Date: May 18, 2017

(54) Package Box for Containing Object and Being Turned Inside Out to Form Pet Kit

(71) Applicant: Petsweet Co., Ltd., Taipei City (TW)

(72) Inventor: Chia-Hsiang Ting, Taipei City (TW)

(21) Appl. No.: 14/940,240

(22) Filed: Nov. 13, 2015

(51) Int. Cl. B65D 81/36; B65D 5/02; B65D 5/46; A01K 15/02

(52) U.S. Cl. CPC B65D 81/368; A01K 15/024; A01K 15/027; B65D 5/02; B65D 5/46008

(57) ABSTRACT

A package box for containing an object and being turned inside out to form a pet kit includes: a bottom panel; four lateral panels integrally formed with the bottom panel; a top panel coupled to the lateral panels by joint structures, wherein the bottom panel and the lateral panels together define a receiving space for receiving the object, and the top panel caps the receiving space; and a cat scratching pad fixedly disposed on the back of one lateral panel and penetrated by a geometric hole. A geometric perforation corresponding in shape to the geometric hole is formed on two opposite lateral panels. Users unfold the package box and then fold it inside out to form a pet kit, expose the cat scratching pad, and remove a plate from within the geometric perforation, such that the pet kit is equipped with a cat maze playground and the cat scratching pad.

### BACKGROUND OF THE INVENTION

Technical Field

The present invention relates to the technical field of pet-related consumer products and more particularly to a package box for containing an object and being turned inside out to form a pet kit such that the package box, whose traditional value lies in shopping, is not discarded but unfolded and then folded inside out to form a boxlike structure and expose a cat scratching pad that is otherwise hidden inside the package box, so that the boxlike structure provides a cat maze that comes with the cat scratching pad when plates are removed from within perforations, so as to enhance environmental protection and recycling.

Description of Prior Art

Patent application 103300512, entitled Cat Box, discloses a cat box which essentially comprises a hollow-cored cube. As shown in a front view of the cat box, a geometric pattern seemingly illustrative of the top of a cat's and the cat's ears is disposed on the front of the cube. An oblique cutting line is disposed right below the pattern. An oblong opening is centrally disposed on the top of the cube and provided with a handle. A large-area round hole is disposed on the left face of the cube and on the rear face of the cube. The round holes penetrate the left and rear faces of the cube, respectively. The cube further has a trapezoidal pattern. The trapezoidal pattern starts from the left face, passes the front face, the right face, and ends at the rear face in sequence, with its height decreasing gradually while it is going around the cube.

The cat box disclosed in patent application 103300512 serves a purpose solely as its name suggests; hence, it cannot function as a package box for use in shopping. Furthermore, the odds are that any object contained in the cat box will escape via the large-area round hole of the cat box; as a result, the cat box cannot carry any object for sale but functions only as a cat box. Moreover, the cat box cannot be turned inside out. Even if the cat box is turned inside out, it will not serve any special purpose. Therefore, turning the cat box inside out makes no sense.

### SUMMARY OF THE INVENTION

It is an objective of the present invention to provide a package box for containing an object and being turned inside out to form a pet kit such that the package box, whose traditional value lies in shopping, is not discarded but unfolded and then folded inside out to form a boxlike structure and expose a cat scratching pad that is otherwise hidden inside the package box, so that the boxlike structure provides a cat maze that comes with the cat scratching pad when plates are removed from within perforations, so as to enhance environmental protection and recycling.

In order to achieve the above and other objectives, the present invention provides a package box for containing an object and being turned inside out to form a pet kit. The package box comprises at least six panels, namely a bottom panel, four lateral panels and at least one top panel. The bottom panel is integrally formed with the four lateral panels. The four lateral panels are coupled to the at least one top panel by joint structures. The bottom panel and the four lateral panels together define a receiving space for receiving the object. The at least one top panel caps the receiving space. A cat scratching pad is fixedly disposed on and protrudes from the back of at least one of the lateral panels. The cat scratching pad is centrally penetrated by a geometric hole. A geometric perforation corresponding in shape to the geometric hole is formed on the lateral panel and on the one opposite thereto. Hence, after buying the package box and the object therein, a user takes the object out of the package box. Afterward, the user has the empty package box unfolded and then folded inside out to form a boxlike structure, expose a cat scratching pad that is otherwise hidden inside the package box, remove plates from within geometric perforations, such that the boxlike structure turns into a maze box with a cat maze playground and the cat scratching pad. Both the pet kit and cat scratching pad are made of a material which is eco-friendly and recyclable. Therefore, the package box of the present invention is environmentally friendly, regenerable, and multipurpose.

### BRIEF DESCRIPTION OF THE DRAWINGS

FIG. 1 is a perspective view of a package box unfolded to reveal its outside according to an embodiment of the present invention;

FIG. 2 is a perspective view of the package box unfolded to reveal its inside according to an embodiment of the present invention;

FIG. 3 is a perspective view of the package box according to an embodiment of the present invention;

FIG. 4 is a perspective view of a pet kit formed by unfolding the package box and then folding it inside out according to an embodiment of the present invention;

FIG. 5 is a perspective view of another package box unfolded to reveal its outside according to another embodiment of the present invention;

FIG. 6 is a perspective view of the package box unfolded to reveal its inside according to another embodiment of the present invention;

FIG. 7 is a perspective view of the package box according to another embodiment of the present invention; and

FIG. 8 is a perspective view of a pet kit formed by unfolding the package box and then folding it inside out according to another embodiment of the present invention.

### DETAILED DESCRIPTION OF THE EMBODIMENT OF THE INVENTION

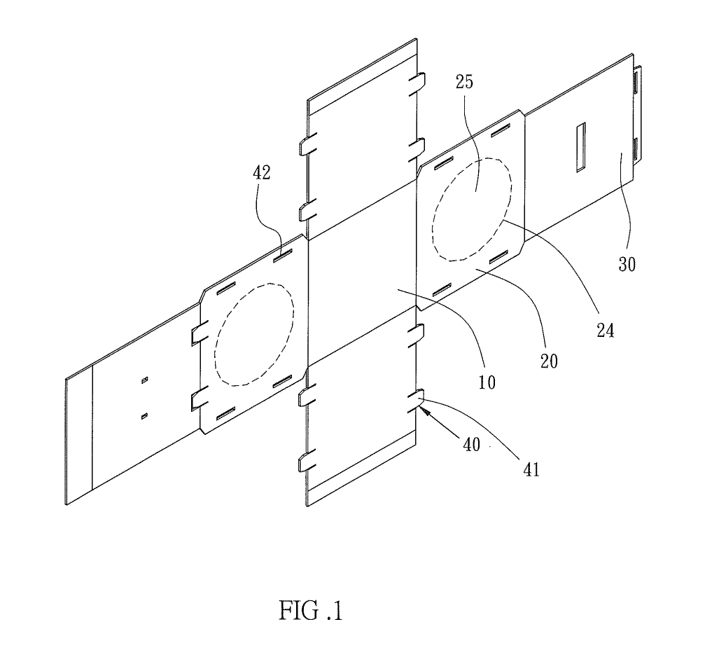

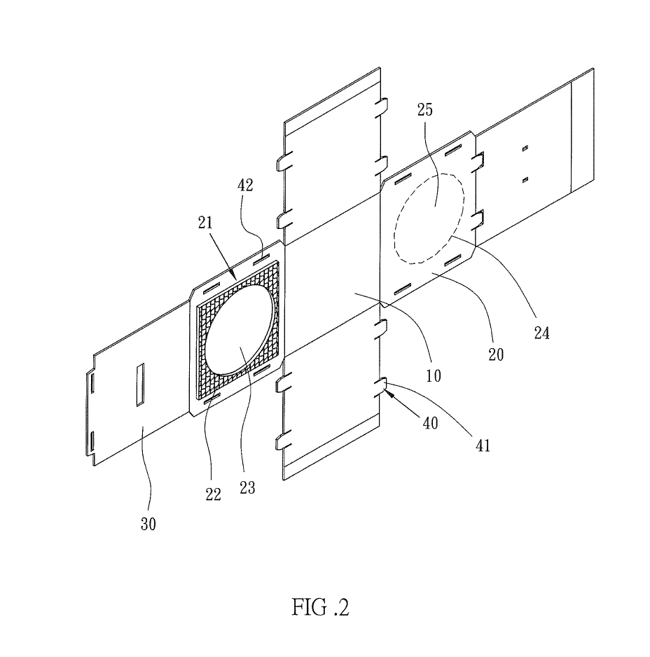

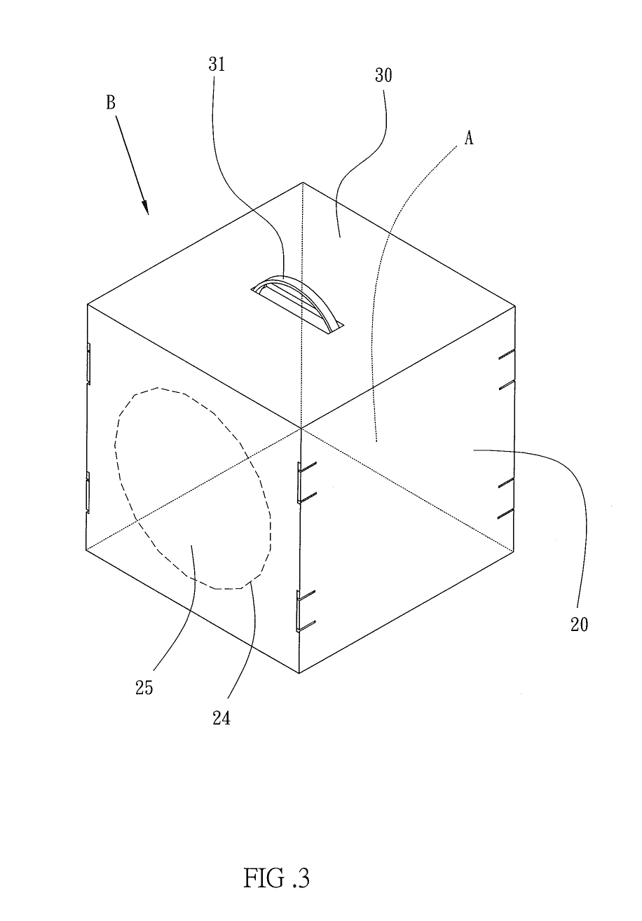

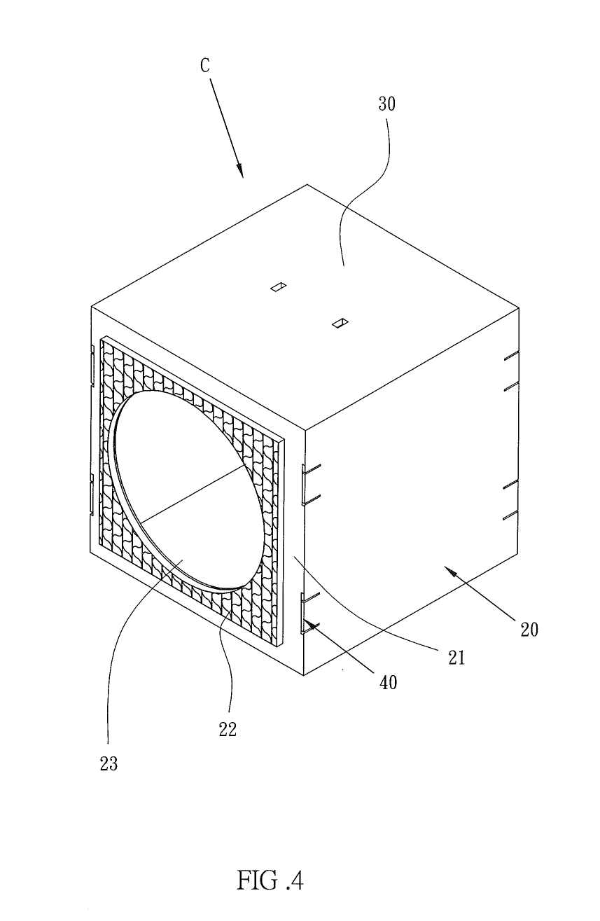

Referring to FIG. 1 through FIG. 4, the present invention provides a package box for containing an object and being turned inside out to form a pet kit. The package box essentially comprises a bottom panel 10, four lateral panels 20, and at least one top panel 30. The bottom panel 10 is integrally formed with the four lateral panels 20. The four lateral panels 20 are coupled to the at least one top panel 30 by joint structures 40. The bottom panel 10 and the four lateral panels 20 together define a receiving space A. The receiving space A receives the object. The at least one top panel 30 caps the receiving space A. Therefore, the aforesaid elements together form a package box B which contains the object for sale.

A cat scratching pad 22 is fixedly disposed on and protrudes from a back 21 of at least one of the lateral panels 20. The cat scratching pad 22 is centrally penetrated by a geometric hole 23. A geometric perforation 24 corresponding in shape to the geometric hole 23 is formed on the lateral panel 20 and on the one opposite thereto. After buying the package box B and the object therein, a user takes out the object. Afterward, the user has the empty package box B unfolded and then folded inside out to form a pet kit C, expose the cat scratching pad 22, and remove a plate 25 from within the geometric perforation 24, such that pet kit C is equipped with a cat maze playground and the cat scratching pad 22. Both the pet kit C and the cat scratching pad 22 are made of a material which is eco-friendly and recyclable. Therefore, the package box of the present invention is environmentally friendly, regenerable, and multipurpose.

Regarding the package box for containing an object and being turned inside out to form a pet kit, the joint structures 40 are adhesive adapted for repeated use.

Regarding the package box for containing an object and being turned inside out to form a pet kit, the joint structures 40 are hook-and-loop fasteners adapted for repeated use.

Regarding the package box for containing an object and being turned inside out to form a pet kit, the joint structures 40 are a male pin 41 and a female slot 42 adapted for repeated use.

Regarding the package box for containing an object and being turned inside out to form a pet kit, the geometric hole 23 is preferably round.

Regarding the package box for containing an object and being turned inside out to form a pet kit, a handle 31 is disposed on the top panel 30 and exposed from the package box B.

Regarding the package box for containing an object and being turned inside out to form a pet kit, a cat scratching pad 22 is fixedly disposed on and protrudes from the back 21 of the at least one of the lateral panels 20, and the cat scratching pad 22 is preferably fixedly disposed on and protrudes from the backs 21 of two lateral panels 20.

Regarding the package box for containing an object and being turned inside out to form a pet kit, a cat scratching pad 22 is fixedly disposed on and protrudes from the back 21 of the at least one lateral panel 20, and the cat scratching pad 22 is preferably fixedly disposed on and protrudes from the backs 21 of three lateral panels 20.

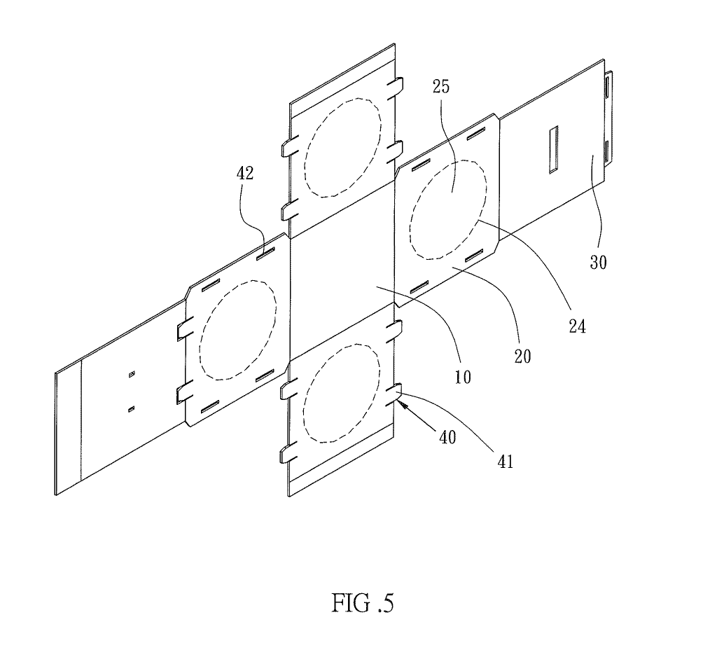

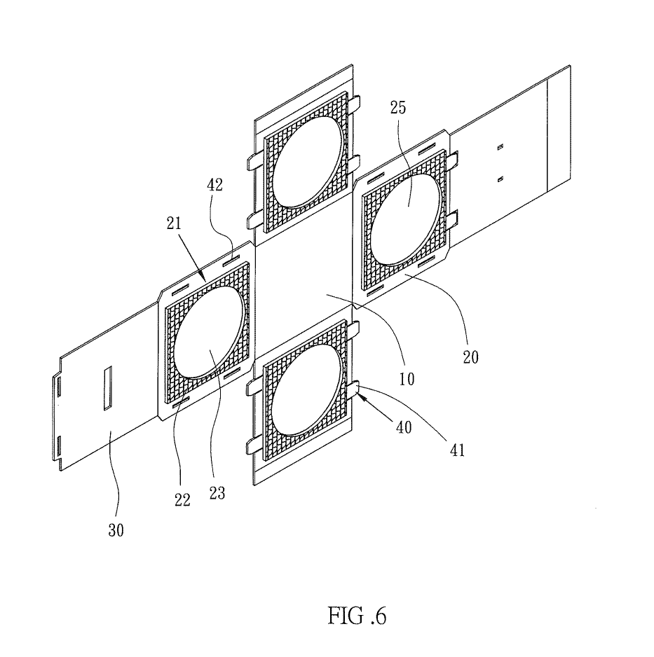

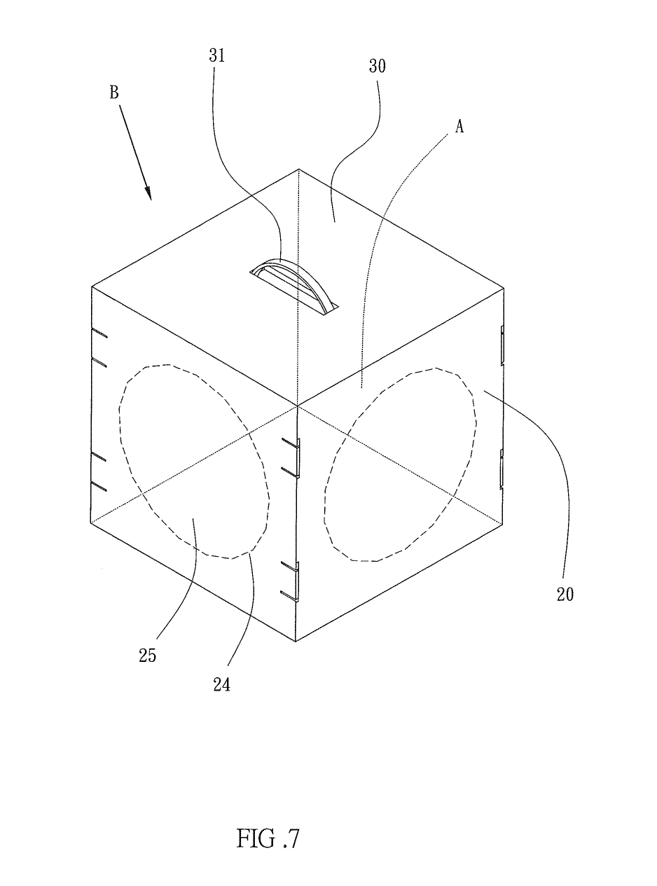

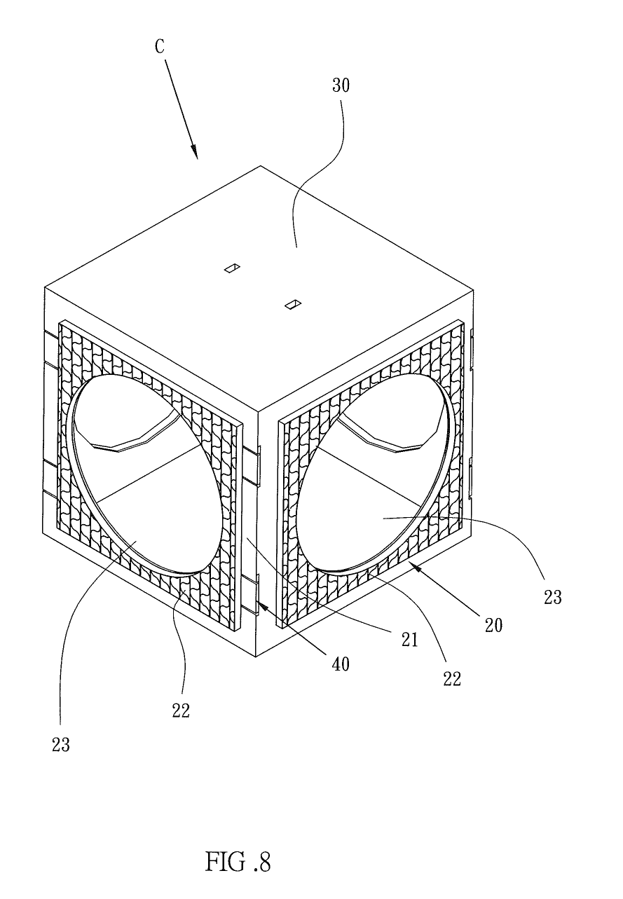

Referring to FIG. 5 through FIG. 8, the present invention provides a package box for containing an object and being turned inside out to form a pet kit. The package box essentially comprises a bottom panel 10, four lateral panels 20, and at least one top panel 30. The bottom panel 10 is integrally formed with the four lateral panels 20. The four lateral panels 20 are coupled to the at least one top panel 30 by joint structures 40. The bottom panel 10 and the four lateral panels 20 together define a receiving space A. The receiving space A receives the object. The at least one top panel 30 caps the receiving space A. Therefore, the aforesaid elements together form a package box B which contains the object for sale. A cat scratching pad 22 is fixedly disposed on and protrudes from a back 21 of each of the four lateral panels 20. The cat scratching pads 22 are each centrally penetrated by a geometric hole 23. A geometric perforation 24 corresponding in shape to the geometric hole 23 is formed on each lateral panel 20. After buying the package box B and the object therein, a user takes out the object. Afterward, the user has the empty package box B unfolded and then folded inside out to form a pet kit C, expose all the cat scratching pads 22, and remove the plates 25 from within the geometric perforations 24, respectively, such that the pet kit C is equipped with a cat maze playground and the cat scratching pads 22. Both the pet kit C and the cat scratching pads 22 are made of a material which is eco-friendly and recyclable. Therefore, the package box of the present invention is environmentally friendly, regenerable, and multipurpose.

Regarding the package box for containing an object and being turned inside out to form a pet kit, the joint structures 40 are adhesive adapted for repeated use.

Regarding the package box for containing an object and being turned inside out to form a pet kit, the joint structures 40 are hook-and-loop fasteners adapted for repeated use.

Regarding the package box for containing an object and being turned inside out to form a pet kit, the joint structures 40 are a male pin 41 and a female slot 42 adapted for repeated use.

Regarding the package box for containing an object and being turned inside out to form a pet kit, the geometric hole 23 is preferably round.

Regarding the package box for containing an object and being turned inside out to form a pet kit, a handle 31 is disposed on the top panel 30 and exposed from the package box B.

As indicated above, the package box of the present invention, which is capable of containing an object and being turned inside out to form a pet kit, is not only novel and thus meets the novelty requirement of patentability, but is also comprehensively innovative and thus meets the non-obviousness requirement of patentability. Furthermore, despite its traditional shopping purpose and disposability, the package box is not thrown away but is unfolded and then folded inside out to form a boxlike structure, expose a cat scratching pad that is otherwise hidden inside the package box, remove plates from within perforations, such that the boxlike structure turns into a maze box with a cat maze playground and the cat scratching pad to thereby enhance environmental protection and recycling, thereby having high industrial applicability.

What is claimed is:

1. A package box for containing an object and being turned inside out to form a pet kit, the package box comprising:
a bottom panel;
four lateral panels integrally formed with the bottom panel;
at least one top panel coupled to the four lateral panels by joint structures, wherein the bottom panel and the four lateral panels together define a receiving space for receiving the object, and the at least one top panel caps the receiving space; and
a cat scratching pad fixedly disposed on and protruding from a back of at least one of the lateral panels, with the cat scratching pad centrally penetrated by a geometric hole, such that a geometric perforation corresponding in shape to the geometric hole is formed on the lateral panel and on the one opposite thereto, wherein, after buying the package box and the object therein, a user takes out the object to have the package box unfolded and then folded inside out to form a pet kit, expose the cat scratching pad, and remove a plate from within the geometric perforation, such that the pet kit is equipped with a cat maze playground and the cat scratching pad, wherein the pet kit and the cat scratching pad are made of an eco-friendly recyclable material.

2. The package box of claim 1, wherein the joint structures are adhesive adapted for repeated use.

3. The package box of claim 1, wherein the joint structures are hook-and-loop fasteners adapted for repeated use.

4. The package box of claim 1, wherein the joint structures are a male pin and a female slot adapted for repeated use.

5. The package box of claim 1, wherein the geometric hole is preferably round.

6. The package box of claim 1, wherein a handle is disposed on the top panel and exposed from the package box.

7. The package box of claim 1, wherein a cat scratching pad is fixedly disposed on and protrudes from the back of the at least one of the lateral panels and is preferably fixedly disposed on and protrudes from the backs of two said lateral panels.

8. The package box of claim 1, wherein a cat scratching pad is fixedly disposed on and protrudes from the back of the at least one of the lateral panels and is preferably fixedly disposed on and protrudes from the backs of three said lateral panels.

9. A package box for containing an object and being turned inside out to form a pet kit, the package box comprising:
a bottom panel;
four lateral panels integrally formed with the bottom panel;
at least one top panel coupled to the four lateral panels by joint structures, wherein the bottom panel and the four lateral panels together define a receiving space for receiving the object, and the at least one top panel caps the receiving space; and
a cat scratching pad fixedly disposed on and protruding from a back of each said lateral panel, with the cat scratching pads each centrally penetrated by a geometric hole, such that a geometric perforation corresponding in shape to the geometric hole is formed on each said lateral panel, wherein, after buying the package box and the object therein, a user takes out the object to have the package box unfolded and then folded inside out to form a pet kit, expose the cat scratching pads, and remove plates from within the geometric perforations, respectively, such that the pet kit is equipped with a cat maze playground and the cat scratching pad, wherein the pet kit and the cat scratching pads are made of an eco-friendly recyclable material.

10. The package box of claim 9, wherein the joint structures are adhesive adapted for repeated use.

11. The package box of claim 9, wherein the joint structures are hook-and-loop fasteners adapted for repeated use.

12. The package box of claim 9, wherein the joint structures are a male pin and a female slot adapted for repeated use.

13. The package box of claim 9, wherein the geometric hole is preferably round.

14. The package box of claim 9, wherein a handle is disposed on the top panel and exposed from the package box.
